(19) United States
(12) Patent Application Publication
(10) Pub. No.: US 2015/0017490 A1
(43) Pub. Date: Jan. 15, 2015

(54) PLANAR ALKALI METAL-BETA BATTERY

(71) Applicant: Material and Systems Research, Inc., Salt Lake City, UT (US)

(72) Inventors: Gege Tao, Sandy, UT (US); Neill Weber, Salt Lake City, UT (US); Anil V. Virkar, Salt Lake City, UT (US)

(73) Assignee: Material and Systems Research, Inc., Salt Lake City, UT (US)

(21) Appl. No.: 13/938,165

(22) Filed: Jul. 9, 2013

(51) Int. Cl. H01M 10/0562; H01M 10/054

(52) U.S. Cl. CPC H01M 10/0562; H01M 10/054
USPC 429/61; 429/209; 429/319; 429/160; 429/149

(57) ABSTRACT

An advanced planar alkali metal-beta battery made by stacking a plurality of individual planar cells, where the individual cells comprises a one-piece ceramic unibody construction with an interior divided by an alkali-ion conducting solid electrolyte into separate cathode and anode compartments. The cathode comprises a premanufactured solid pellet of active cathode materials. A bellows is provided to reduce pressure accumulation in the cathode compartment.

### FEDERAL SUPPORT

This invention as made with support from United States Government, and the United States Government has certain rights in this invention pursuant to the United States National Science Foundation prime contract number IIP-1047369 and IIP-1230459.

### BACKGROUND

Environmentally friendly renewable energy (wind, solar, geothermal, biomass, etc.) has been attracting considerable attention, driven primarily by the need for national energy security and energy independence. Low cost and increasing viability of renewable technologies, coupled with concerns over climate change, sustainability, and rising secondary costs of conventional power generation has led to an ever increasing penetration of renewable technologies into the energy sector. However a fast deployment and market penetration of large scale renewable energy is hampered by its inherent intermittent and seasonal nature and a lack of demand based control, which complicates the operation (load leveling and regulation) of a grid-connected installation. Many technologies are potentially capable of storing renewable energy and releasing it to the grid during times of heavy needs.

The alkali metal-beta rechargeable battery, including the sodium-sulfur (Na—S) battery and the sodium-metal halide battery (i.e. Na—NiCl₂-based ZEBRA battery, Na—FeCl₂, Na—CuCl₂, Na—ZnCl₂, etc.), has shown to be a promising contender for electrical energy storage applications. The alkali metal-beta battery is typically constructed with an alkali-ion conducting beta″-alumina (β″-Al₂O₃) solid electrolyte (BASE), sandwiched between an alkali-metal anode and either a sulfur cathode or a metal halide cathode. The alkali-metal can be sodium, potassium, lithium, rubidium, etc. Compared to lithium, sodium and potassium are less expensive and each is two to three orders of magnitude more abundant than lithium. Thanks to their lower melting points (97.8° C. and 63.38° C. for Na and K, respectively), batteries with liquid sodium or potassium anode are more desirable for higher charge/discharge current densities and are less prone to dendrite formation than a battery with a lithium anode.

Alkali metal-beta batteries use a refractory ceramic electrolyte, which is typically characterized as a rhombohedral crystal structure (R3m) capable of transporting alkali ions (e.g., Na⁺, K⁺ or Li⁺). The ceramic electrolyte (BASE) has a high melting point well above 1650° C., highly corrosion-resistant, and excellent thermodynamic and kinetic stability. At 300° C., the conductivities of the Na⁺-conducting BASE (Na-BASE) and the K⁺-conducting BASE (K-BASE) are in excess of 0.25 S/cm and 0.05 S/cm, respectively.

Alkali metal-beta batteries are commonly constructed with a monolithic cylindrical BASE, and are conventionally fabricated on an industrial-scale by a few mature processes based-on various precursor materials and corresponding β″-Al₂O₃ synthesizing routes, such as the solid-state reaction of α-Al₂O₃ with Na₂O and stabilized with Li₂O or MgO. These fabrication processes require the use of expensive MgO or platinum containers to suppress the soda (Na₂O) vapor phase loss during the high temperature sintering (˜1600° C.). The processes also inevitably leave hydrophilic remnant NaAlO₂ along the β″-Al₂O₃ grain boundaries of the product, making the product susceptible to moisture and carbon dioxide attack from the environment. This results in weakened mechanical strength and possible crack/fracture of BASE. In addition, proper storage and handling protocols must be implemented to maintain pristine properties of BASE.

There are also other challenges that the state-of-the-art alkali metal-beta batteries face. First, alkali metal batteries are usually assembled from individual tubular cells. It is necessary to bundle a number of tubular cells to meet certain performance requirements (e.g. power or voltage requirements) by interconnecting those individual tubes electrically in series, parallel, and/or a combination of series and parallel to form a battery pack. However, a battery with a tubular platform sacrifices optimum electrical performance, i.e. minimum ohmic losses inside the battery. The current path in the tubular BASE, which has the lowest conductivity compared to other battery components, is long (electric current typically takes off from two ends of a tubular BASE) leading to large ohmic area-specific-resistance (ASR) losses and thus resulting in low specific energy densities and power densities.

Second, batteries with tubular electrolytes have limited design flexibility, because the specified energy/volume ratio determines the battery cell dimension and specific power density. Typically a tubular cell has an unfavorably low ratio of active area (active surface area of a BASE) to cell volume. For energy storage application a high ratio is usually much more desirable.

Third, due to its tubular architecture, the structural integrity of each battery cell depends solely on the ceramic BASE, which typically has fracture strength on the order of 200 MPa or less. Consequently, a BASE with a wall thicker than 0.15 cm is necessary for maintaining the battery cell mechanical integrity, which inevitably results in large ohmic losses.

Fourth, during high temperature operation and deep charge/discharge cycles, a high vapor pressure of sulfur (for the NaS battery case) and AlCl₃ evolved from the NaAlCl₄ molten electrolyte (for the Na-metal halide battery case) will be developed on the battery cathode side. This poses concerns about the integrity of the seals and the ceramic BASE rupture.

Fifth, the sodium-metal halide battery is typically assembled under a fully discharged stage where the anode compartment may contain a residual gas. During the initial charge, the sodium is electrochemically stripped from the NaCl on the cathode and liquid sodium is formed accumulatively in the anode compartment. This compresses gas already inside the anode compartment, resulting in high pressure as the compartment fills with sodium, and resulting in possible rupture of the anode compartment seal or failure of the ceramic BASE.

Recognizing the inherent problems of the relatively low BASE strength, the requirements for special storage/handling, the low electrical performance, and the high risk of breaking seals or BASE, there is a dire need for a better design with safety improvements over the state-of-the-art alkali metal-beta battery.

### SUMMARY

Described is an electrochemical device and a battery, and more particularly to a system and design for manufacturing of a rechargeable battery comprising an alkali metal anode, a metal halide cathode, and an alkali metal-ion conducting solid electrolyte in the art of flat or planar shape of any one of circular, ovoid, regular or irregular polygonal with straight or curved sides for energy storage applications.

This device provides a unique concept leading to a better design and manufacture of a planar alkali metal-beta battery with improved electrical performance and safety.

An aspect is a battery cell comprising: a unibody ceramic header; a planar alkali-ion-conducting solid electrolyte, the header generally cylindrical shaped with a generally cylindrical hollow interior with first open and second open ends, the cylindrical interior of the ceramic header configured with a protruding rim engaging and sealed to the edges of the solid electrolyte to separate the hollow interior into separate compartments, a cathode compartment opening at the first end, and an anode compartment opening at the second end. A cathode end cover at the first end closes the cathode compartment with a seal. An anode end cover at the second end closes the anode compartment with a seal.

In an aspect, the cathode comprises a single solid unitary compressed cathode pellet sealed in the cathode compartment. Active cathode materials are included in the pellet.

The cathode pellet may be produced by, for example, die pressing into a single pellet. Use of a pore former can provide a porous structure enabling easy infiltration and well distribution of the secondary electrolyte among the cathode materials in the single solid pellet. This construction adapts well to faster fabrication and possible automation of the fabrication process of the cell. This contrasts with the prior-art practice of pouring granular, multi-pellet materials in a cathode compartment followed by settling/filling steps.

In another aspect, the anode compartment in a newly fabricated cell contains a vacuum. This is accomplished by sealing the anode compartment while under vacuum. During charging as the anode compartment fills with anode liquid, but pressure increases are mitigated since the incoming liquid displaces little or no gasses existing in the compartment.

In another aspect, the planar alkali-ion-conducting solid electrolyte has a texture surface adjacent to either or both the anode and the cathode to increase the active area of the electrolyte.

Generally, the cross-sections of the planar or disc-shaped solid electrolyte and the inside of the ceramic header are circular, but they may have non-circular cross-sections, such as ovoid, regular (square, hexagon) or irregular polygonal with straight or curved sides.

A common ceramic for construction of electrochemical cells is alumina because of its modest cost, high-resistance to corrosion attacks from the electrode materials, and high temperature properties. In some applications, a thermal expansion mismatch between cell components and a solid electrolyte can lead to failure of ceramic components under thermal cycling conditions. To mitigate this problem, an aspect is matching the coefficient of the thermal expansion (CTE) of the ceramic of the unibody header, and the ceramic of the alkali-ion-conducting solid electrolyte.

Usually cells are stacked into a series configuration. To assist in assembling the stack and maintain the electrical and physical integrity of the stack, an aspect is providing a knob near the center of the cathode cover to improve electrical contact with an anode cover of an adjacent cell and assist in registration with the adjacent cell.

A problem with series assembled stacks is that if one cell faults in either open circuit or high resistance, it disrupts function of the entire series leg of the stack. Accordingly, an aspect is a clamp, such of c-clamp design, which bypasses a malfunctioning cell with a moderated battery capacity. This can be provided by having lips, extension, or structures on either or both anode and cathode covers that can engage the clamp and allow it to bridge the cell unibody header. Clamps can be dimensioned to bypass one or more than one cell.

During operation of the cell, gasses in the cathode compartment can produce excessive pressures that can lead to seal rupture and cell failure. To mitigate and reduce pressure buildup, an aspect is a bellows that is structurally compliant to pressure and volume conditions in the cathode compartment. The bellows is suitably disposed between the cathode end cap and the unibody header.

An embodiment consists of a stack of at least two planar alkali metal-beta battery cells intimately connected electrically, as shown in FIG. 1. A metal can provides a housing for the stack of battery cells and serves as a negative terminal, while a battery end cap serves as a positive terminal. A spring on top, which is always under compression, is used to ensure good electrical contacts among the individual battery cells and accommodates space changes resulting from battery electrochemical reactions. An insulation sleeve separates the exterior of each individual cell from the negative terminal (metal can).

FIG. 3 illustrates a schematic of a planar, alkali metal-beta single-cell battery under a fully discharge stage, which is the constituent of a battery assembly as shown in FIG. 1. The unique “unibody” design of a battery cell overcomes drawbacks of the-state-of-the-art tubular sodium-beta batteries (including NaS battery and Na-metal halide battery), and facilitates the development of a compact, cost-effective battery system for electrical energy storage applications with improved reliability and safety. Exemplary cell components are delineated in detail below:
(a) A refractory ceramic header 123 providing the electrode compartments as a “unibody” for both cathode compartment 127 and anode compartment 125. Composition of the compartment header is engineered such that its CTE matches that of the planar BASE disc 121.
(b) An alkali-ion conducting solid electrolyte (e.g. Na-BASE, K-BASE, or Li-BASE) disc 121, which can be fabricated using a vapor phase process or by other and conventional processes.
(c) Surfaces of the BASE disc are textured to increase the active electrolyte area.
(d) The BASE disc 121 is jointed to a protruding rim 129 being a part of the unibody ceramic header 123 via a glass seal 153, thus dividing the ceramic header 123 into the cathode compartment 127 and the anode compartment 125.
(e) The top flat surface of the cathode compartment 127 is metallized by a molybdenum-manganese layer, followed by nickel plating 149.
(f) A metallic flange ring 151 is attached to the top flat surface of the cathode compartment 127 through the molybdenum-manganese metallization layer 149 via a high-temperature thermocompression bonding (TCB) technique.
(g) The flange ring 151 and the cathode end cover 131 are welded to a bellows 135, which provides compliance to adjust pressure changes inside the cathode compartment 127 without cracking a hermetic seal.
(h) The cathode end cover 131 is stamped to form a knob 133 in center, which is also welded to a cathode current conducting strip 137 from the inside.
(i) A cathode pellet 130 is formed by pressing active cathode materials, such as NaCl and nickel powders, followed by infiltration of the secondary electrolyte (NaAlCl₄) under vacuum.
(j) The cathode current conducting strip 137 is embedded inside the cathode pellet and provides current paths from the cathode pellet 130 to the cathode end cover 131.
(k) An anode end cover 145 is formed by stamping a flat metal shim into waves 147 in the center providing compliance to gas pressure changes inside the anode compartment.
(l) A metallic anode gasket 157 provides bonding between the anode end cover 145 and the bottom surface of the anode compartment 125 via a low-temperature thermocompression bonding technique.
(m) A metallic wick 141 transports molten sodium between the graphite felt 143 and the anode compartment 125. It also provides a path for electron transport. Additionally, the metallic wick 141 furnishes mechanical supports to the alkali-ion conducting solid electrolyte 121 for the reinforcement of the cell structural integrity when a battery scales up the solid electrolyte with enlarged active areas or adopts a solid electrolyte with a reduced thickness less than 0.05 cm.

Similarly, an embodiment includes a plurality of planar alkali metal-beta battery cells electrically connected in series, parallel, or series/parallel combination to meet various needs for energy storage. In the case of series connection, success of the battery depends on the reliability of each individual cell in a set, since even if just one cell faults, in either open circuit or high resistance, it leads to the failure of the entire series leg. The present device provides a unique and instantaneous fix to the battery by bypassing any malfunctioning battery cell or cells without having to disassemble the whole battery pack. As shown in FIG. 4 as an example, if cell number “n” faults either in open circuit or high resistance, it can be shorted simply through a C-clamp 159 on the cell edge so that electrical current bypasses directly from cells “n−1” to the cell “n+1”.

### BRIEF DESCRIPTION OF DRAWINGS

FIG. 1 is a schematic of a planar alkali metal-beta battery assembly.

FIG. 2 is a schematic of a single cell showing particularly a joint of the positive terminal/cathode end cover.

FIG. 3 is a schematic of a planar alkali metal-beta battery cell.

FIG. 4 is a schematic of a system of bypassing a malfunctioned battery cell.

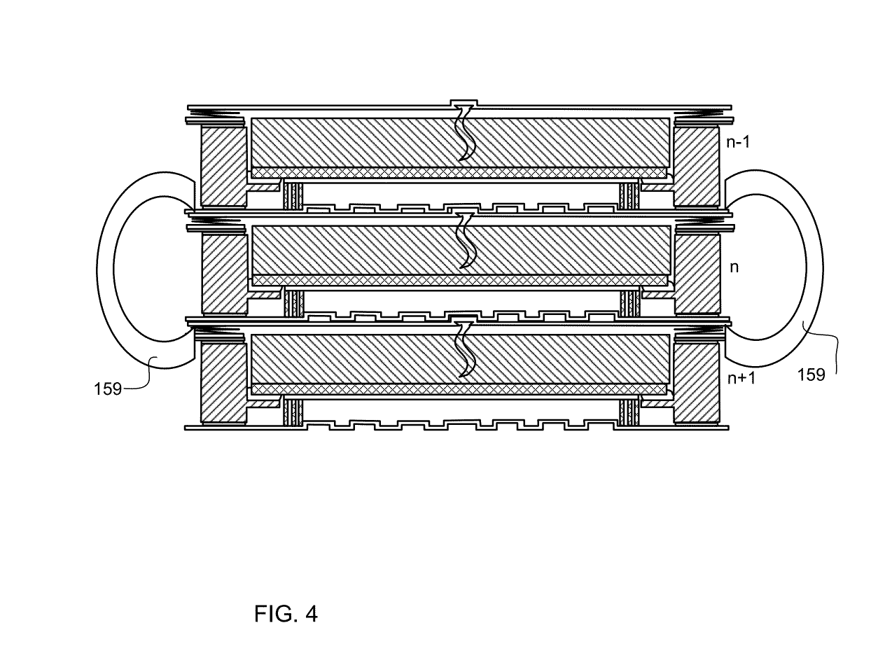

FIG. 5A and FIG. 5B are SEM micrographs of (A) α-Al₂O₃ before conversion and (B) β″-Al₂O₃ after conversion.

FIG. 6 is a graph showing BASE conductivity comparisons among samples fabricated by MSRI's process (U.S. Pat. No. 6,537,940) and samples fabricated by the conventional process (by Ionotec, Cheshire England, and Silent Power Inc., Salt Lake City, Utah).

FIGS. 7A, 7B, 7C, and 7D are photographs showing water boiling tests of BASE tubes and discs.

FIGS. 8A and 8B are (A) a photograph of Na-BASE plates w/surface texturing at micron and millimeter scales, and (B) a SEM micrograph showing the textured surface of a BASE.

FIG. 9 is a graph showing thermal expansion characteristics of the BASE disc and the unibody ceramic header over a temperature ranging from 25° C. to 600° C.

FIG. 10 is a photograph showing six unibody ceramic headers after the molybdenum-manganese metallization.

FIG. 11 is a graph overlying a micrograph of EDX spectroscopy of the seal/joint and elemental profile along the seal/joint.

FIG. 12 is a photograph of sealing joints formed by the anode of a ceramic header, an aluminum gasket ring, and a mild steel disc after the low-temperature TCB process.

FIG. 13 is a graph showing effects of anode residual gas on the anode compartment pressure that potentially the anode seals have to endure.

FIG. 14 is a photograph of a cell assembly (without BASE and electrodes) for helium leak-rate tests.

FIG. 15 is a graph showing leak-rate test results of a battery cell using pressurized helium gas (3 absolute atmospheres) at both room temperature and 300° C.

FIG. 16A and FIG. 16B are photographs of assemblies post pressure endurance tests.

FIG. 17 is a graph showing results of pressure endurance tests.

FIG. 18 is a photograph of a planar, Na—NiCl₂ single-cell battery assembly.

FIG. 19 is a graph showing break-in characteristics of a Na—NiCl₂ single-cell battery.

FIG. 20 is a graph showing voltage characteristics of a planar, Na—NiCl₂ single-cell battery (775 mAh capacity) when cycled at ½C rate (400 mA or 100 mA/cm²) at 300° C.

FIG. 21 is a graph showing characteristics of a planar, Na—NiCl₂ single-cell battery (775 mAh) during (a) discharge and (b) charge. The dependence of OCV on SoC and on cycling is also shown in the plots.

FIG. 22 is a graph showing cell ASR dependency on SoC.

FIG. 23 is a graph showing freeze-thaw survivability tests of a planar, Na—NiCl₂ single-cell battery.

### DETAILED DESCRIPTION

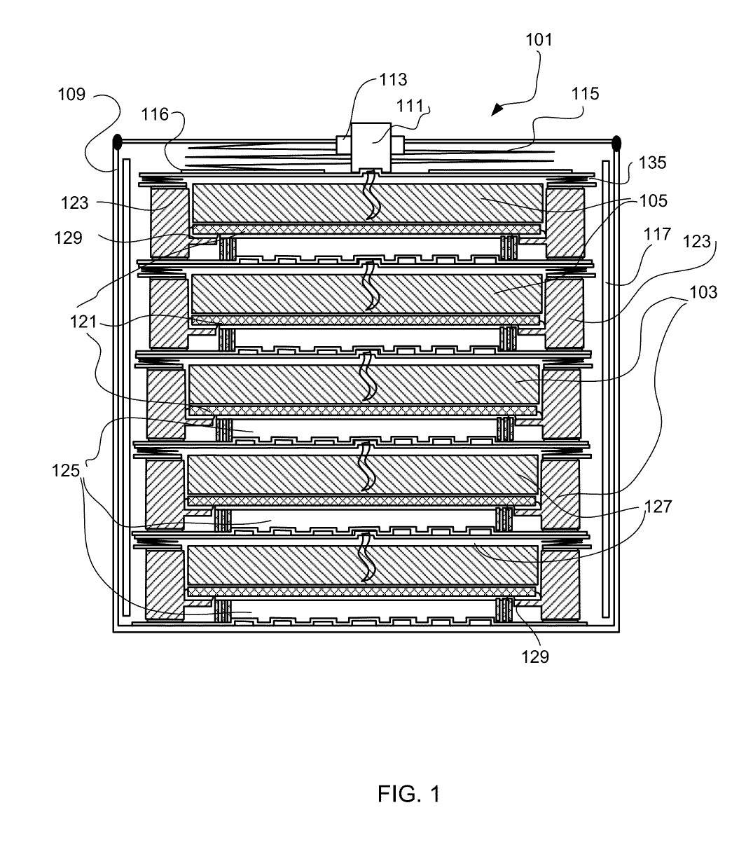

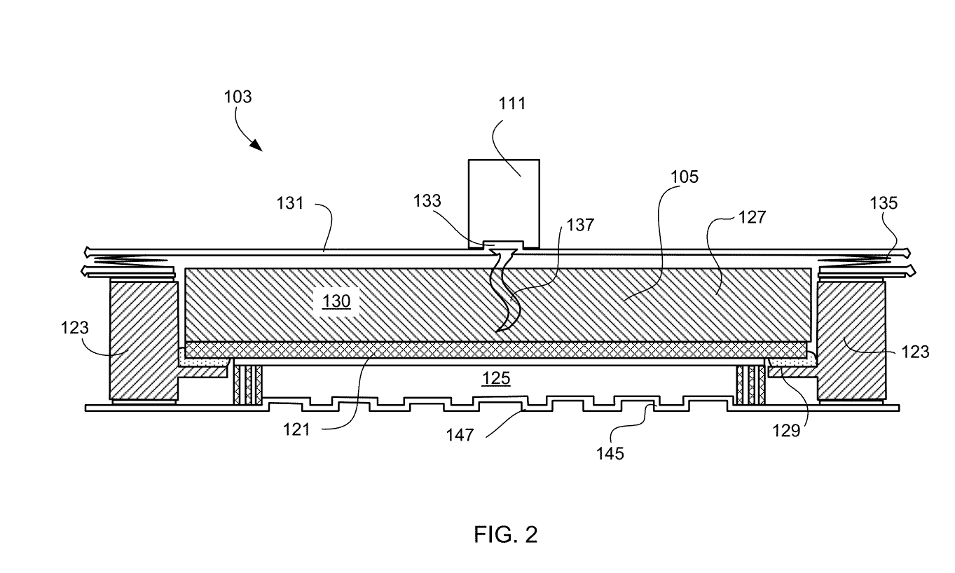

FIG. 1 is a schematic diagram showing a planar alkali metal-beta battery pack 101. This battery pack, as shown in the figure, consists of a plurality of planar alkali metal-beta battery cells 103 that intimately connect each other electrically. The electrode of each battery cell faces an opposite electrode of its adjacent battery cells. For example, the cathode 105 of a battery cell is jointed electrically to the liquid anode (in anode compartment 125) of an adjacent battery cell, forming electrical paths. A metal can 109 provides housing for the stack of battery cells 103 that are seated in the center. The metal can 109 also serves as the negative terminal. A battery end cap 111, which has its concave end socketed into the cathode end cover of the very top (first) battery cell, serves as a positive terminal, as shown in FIG. 2. An insulation sleeve 113 is inserted between the battery cap and the metal can for electrical insulation. A spring 115, which is located on top under compression, is used to keep the stack under compression ensuring good electrical contacts among the individual battery cells. It also accommodates displacement changes resulting from battery stack electrochemical reactions. A thin ring 116, which can be but not limited to be cut from mica or alumina sheets, provides electrical insulation between the spring 115 and the cathode end cover 131 of the first cell. Insulation slabs 117, which fill up the space between the interior wall of the metal can and the outside of the battery individual cells, separate the exterior of the individual cells from the negative terminal (metal can).

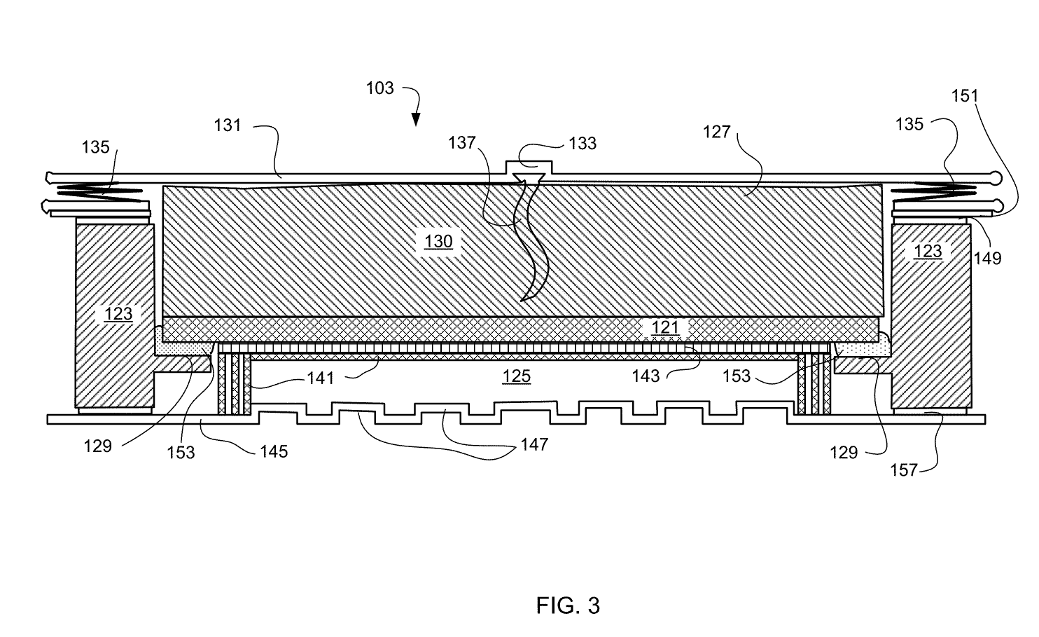

FIG. 3 shows a schematic diagram of a planar, alkali metal-beta battery cell 103 that is an essential element for the battery pack. It is an integral component comprising a planar, alkali-ion conducting BASE electrolyte or separator 121 and a unibody ceramic header 123 for constructing anode and cathode compartments 125, and 127, respectively. The unibody ceramic header 123 is made from a refractory ceramic composite having its material composition similar to that of the alkali-ion conducting BASE 121, thus ensuring the CTE of these two matches each other. An interior wall of the unibody ceramic header also has a protruding rim 129, to which a BASE is jointed via glass seals, subsequently forming an anode compartment and a cathode compartment. The BASE 121 can be a sodium-ion conducting membrane (Na-BASE), a potassium-ion conducting membrane (K-BASE), or a lithium-ion conducting ceramic membrane (Li-BASE).

Also as shown in FIG. 3, the cathode 105 comprises an active cathode pellet 130 infiltrated with the secondary electrolyte (NaAlCl₄), a cathode end cover 131 stamped with a knob in center 133, a bellows 135 either welded or formed providing compliancy to pressure changes from the cathode, a current conducting strip 137 linked between the cathode pellet 130 and the cathode end cover 131, and sealing of the cathode compartment via high-temperature TCB and welding at room temperature.

Similarly, the anode comprises an anode wick 141 made from sheet metal for providing sodium transport paths to/away from the BASE 121 surface, a graphite felt 143, an anode end cover 145 (here shown with optional stamped wave forms 147), and sealing of the anode compartment via low-temperature TCB. The metallic wick 141 also is designed and constructed to furnish mechanical supports to the BASE 121 for the reinforcement of the solid electrolyte structural integrity when a battery cell scales up the solid electrolyte with enlarged active areas or adopts an electrolyte with a reduced thickness less than 0.05 cm. No extra measures are needed for providing mechanical supports to the BASE disc 121, such as meshed-supporting surfaces formed by cross members, electrolyte constructed with ribs, or electrolyte supported by anode with sufficient structural strength, which were disclosed in U.S. Pat. No. 5,053,294, R. P. Sernka and R. K. Taenaka, “Planar Sodium-Sulfur Electrical Storage Cell”.

### EXAMPLES

Following is a description of fabrication, characterization, testing and use of battery cells by use of specific non-limiting examples.

### Example I

### Na-BASE Fabrication

Planar BASE plate or disc fabrication process (MSRI process) was based on the concept of coupled transport as disclosed in U.S. Pat. No. 6,537,940, A. V. Virkar, J-F. Jue and K-Z. Fung, “Alkali-Metal Beta and Beta Alumina and Gallate Polycrystalline Ceramics and Fabrication by a Vapor Phase Method”, which is incorporated by reference and described here in general.

A slurry of a powder mixture of 60 weight % α-Al₂O₃ and 40 weight % yttria-stabilized-zirconia (YSZ) was prepared by mixing the powders with chemical binders and solvents.

The slurry was cast over a flat Mylar surface to form a tape with a desirable thickness (0.05˜0.15 cm).

The tape was laser-cut into pieces of desirable dimensions and geometries.

The cut pieces were sintered in air at ˜1600° C., leading to the formation of a fully dense (>99% of theoretical density) two-phase material containing α-Al₂O₃+YSZ. The actual sintering temperature depends on the quality of powders and can be as low as ˜1400° C.

The sintered pieces were placed in a ceramic crucible surrounded by β″-Al₂O₃ powders (a source of Na₂O). This packing powder was made by conventional calcination, and could be reused numerous times, each time simply replenishing Na₂O by adding Na₂CO₃. The specimen were then heated to ˜1400° C. soaking for a few hours to convert α-Al₂O₃ phase in the sintered pieces into sodium-ion conducting β″-Al₂O₃ phase.

### Example II

### SEM Examination of BASE

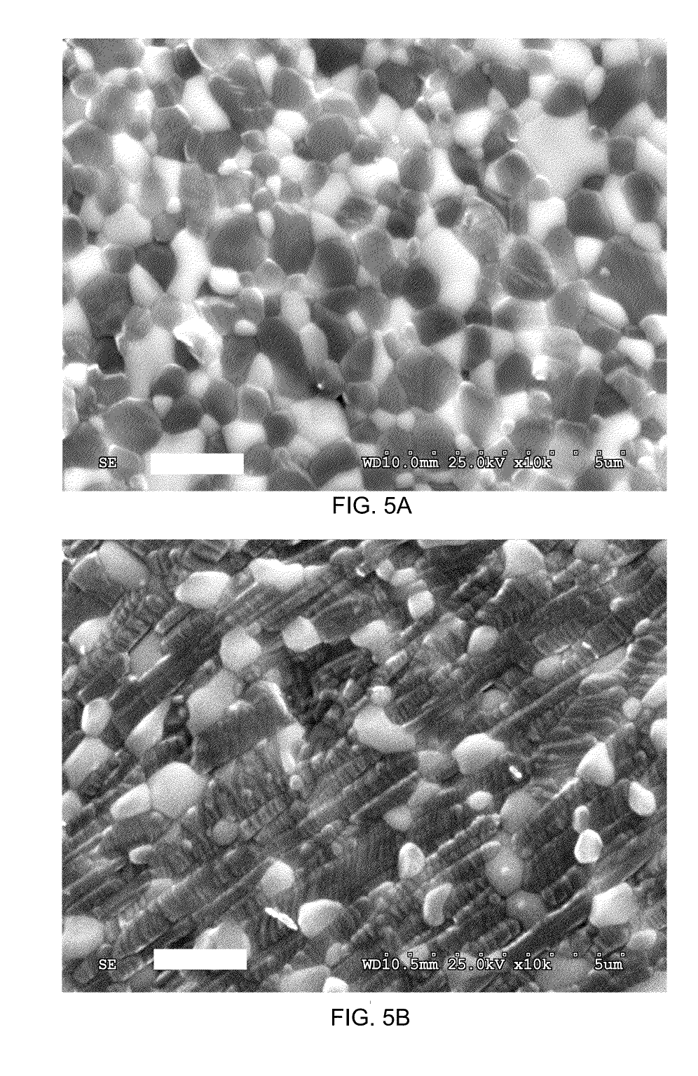

FIGS. 5A and 5B show scanning electron microscope (SEM) study of (A) sintered α-Al₂O₃+YSZ before conversion and (B) sodium ion-conducting β″-Al₂O₃ after conversion. The white grains are YSZ and the dark grains are either α-Al₂O₃ (FIG. 5A) or β″-Al₂O₃ (FIG. 5B). FIG. 5B clearly shows the unique textured grained (beta″) microstructures, which were developed during the vapor-phase conversion process and played a significant role in the attainment of good sodium-ion conductivities. The vapor phase process also readily allowed for the fabrication of thin, flat BASE plates, which are not easily achievable by the conventional process due to warpage associated with liquid phase sintering in the conventional process.

### Example III

### Na-BASE Conductivity Characterization

A sodium-ion conducting BASE made by the vapor phase process certainly shows significant advantages; however, one potential drawback of such BASE is a reduced sodium-ion conductivity resulting from additive of the secondary phase (i.e. YSZ). This side effect can be evaluated by conductivity comparisons to the Na-BASEs fabricated by the conventional processes. BASE samples included both planar and tubular Na-BASE prepared by the vapor phase process (MSRI's BASE), a disc obtained from Silent Power Inc. (SPI), and a tubular BASE obtained from Ionotec. The conductivity was characterized by the AC Electrochemical Impedance Spectroscopy (EIS) measurement (Solartron) using a four-probe setup.

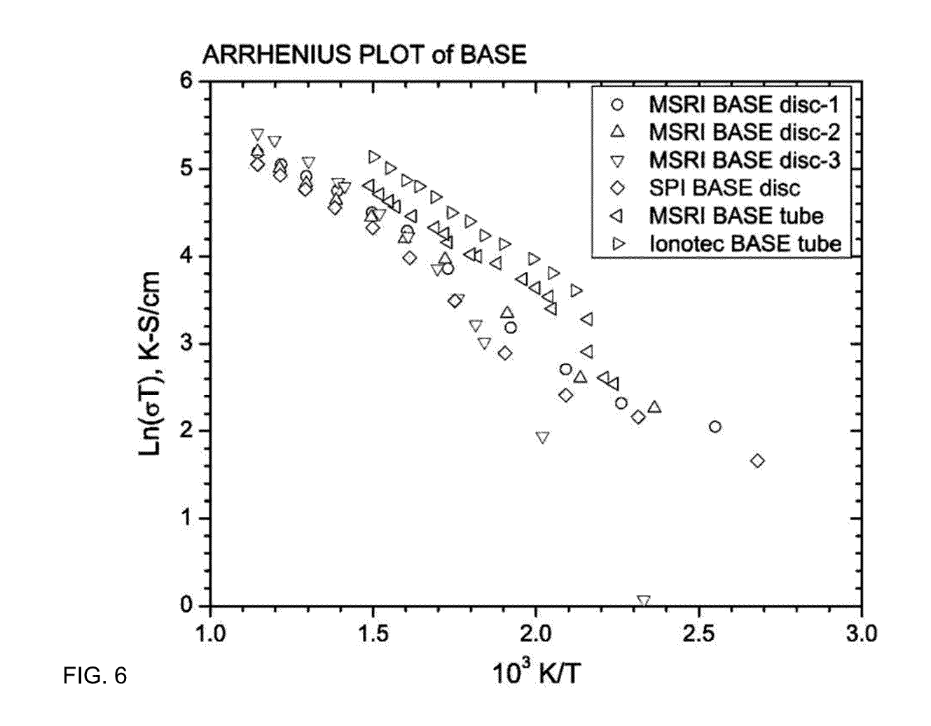

FIG. 6 is the Arrhenius plots, showing the measured ionic conductivities over an extended temperature range from 100° C. to 600° C. As shown in the figure, at 350° C., the ionic conductivity of the MSRI's BASE is ˜0.15 S/cm, which is 30% lower than that of the Ionotec sample (0.21 S/cm). However, the wall thickness of commercially available Na-BASE tube used in NaS and conventional Na-metal halide batteries is well over 0.2 cm, while MSRI's BASE discs can be fabricated as thin as 0.05 cm or thinner (typically 0.12 cm thick). Therefore, the ohmic-ASR of BASE discs fabricated by the MSRI process and by the conventional process (e.g. Ionotec) are estimated to be 0.667 Ωcm² and 0.952 Ωcm², respectively. This indicates that for the alkali metal-beta batteries constructed with same active areas, the ohmic losses attributed to a BASE manufactured by the MSRI's process will be about two third that of a BASE manufactured by the conventional processes.

### Example IV

### Na-BASE Structural Integrity Evaluation

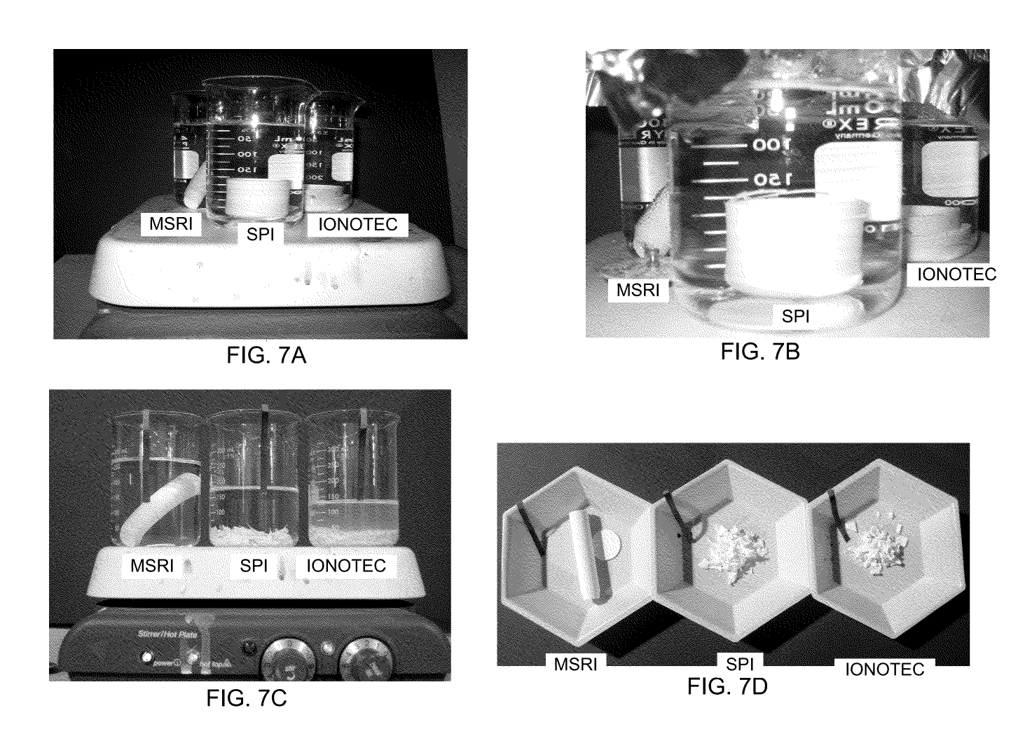

One of the most prominent advantages of the Na-BASE fabricated by the MSRI process is its resistance to moisture and CO₂ attacks since no hydrophilic NaAlO₂ remnant forms along the grain boundaries, unlike BASE manufactured by a conventional process. Boiling in de-ionized water tests were performed to evaluate the structural integrity of Na-BASE samples (both tubes and discs) fabricated by MSRI's process (containing β″-Al₂O₃+YSZ) and by the conventional process (commercial BASE tubes and discs). As shown in FIGS. 7A, 7B. 7C, 7D, the MSRI BASE maintained excellent structural integrity over 60 days in boiling water. However, BASE samples manufactured by other two companies (both SPI and Ionotec) crumbled in the early tests, and water turned strongly basic, consistent with the reaction of NaAlO₂ with water.

It should be noted that while the BASE fabricated by MSRI process is shown to have superior properties, BASE fabricated by other and conventional processes can be used in the present construction to fabricate suitable battery cells.

### Example V

### Reduction of Activation Polarization Via Surface Treatment

To date, all commercially-available tubular Na-BASEs used in Na—S and conventional sodium-metal chloride (i.e. ZEBRA) batteries have smooth electrolyte surfaces, though the macro-scale cruciform (also known as clover-leaf shape or quadric-lobed shape) BASE has been adopted on ZEBRA batteries to increase the active areas.

The role of surface features in lowering activation polarization appears to have been overlooked in the Na—S and conventional ZEBRA battery literatures. Part of the reason for this is due to the difficulty of introducing surface texturing by using the conventional processes, especially on the interior surface of a tubular BASE due to the necessity of removing metallic mandrel (used for shaping the tubular form) after pressing. The currently disclosed planar BASE, however, is readily amenable for the introduction of surface texturing.

Work on SOFC has shown that microstructural features on the oxygen-ion exchange interfaces have a profound influence on activation polarization. It has been shown that if the charge transfer resistance on a smooth surface is given by R_{ct} (Ωcm²), the ionic conductivity of a solid electrolyte is σᵢ (S/cm), and if the dimension of the surface features is given by d (cm), the effective polarization resistance is given by

$${R}_{p} \approx \sqrt{\frac{{R}_{ct} d}{{σ}_{i}}} .$$

### (See A. V. Virkar, J. Chen, C. W. Tanner, and J-W. Kim, Solid State Ionics, 131, (2000), 189-198)

For MSRI BASE discs at 300° C. the electrolyte conductivity σᵢ≈0.1 S/cm. By assuming an average R_{ct}≈2 Ωcm², and d≈0.01 cm, the effective polarization resistance is about 0.447 Ωcm². That is, for the selected values here, the polarization resistance can be reduced by a factor of 2/0.447, or ˜4.47.

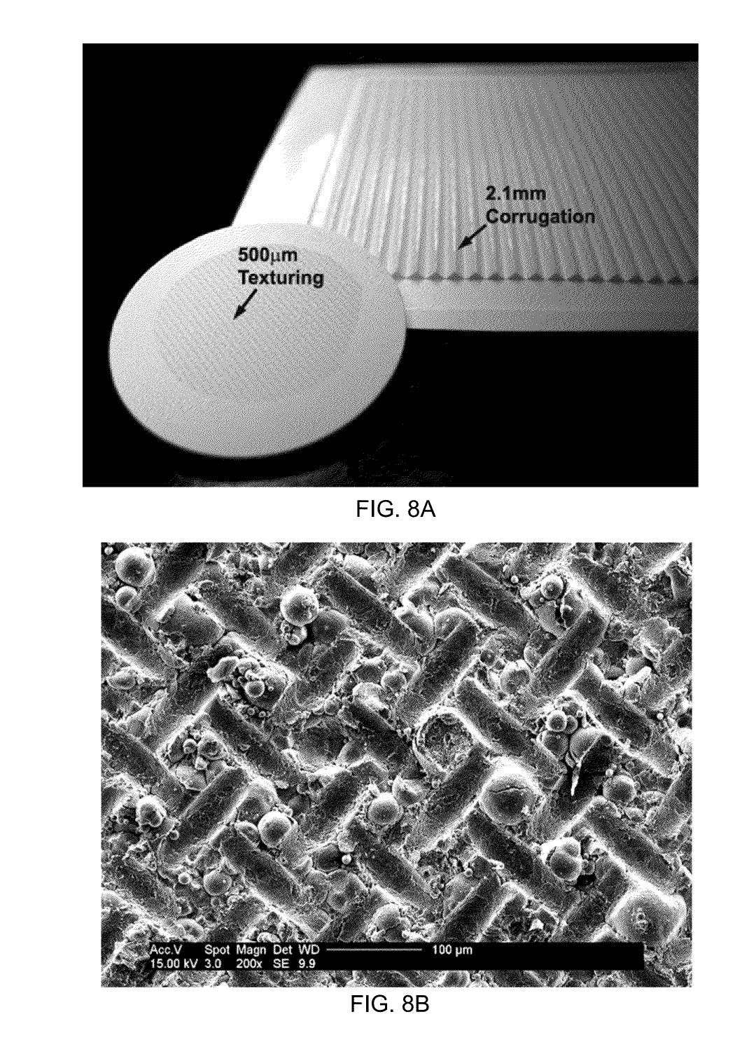

FIG. 8A shows a photograph of two BASE discs with surface texturing by two different patterns. The BASE surface characteristics after the incorporation of surface texturing for minimizing the overall activation polarization were characterized by SEM, as shown in FIG. 8B.

### Example VI

### Composition for Unibody Ceramic Header

The material for constructing the unibody header has to possess a coefficient of thermal expansion matching to that of a BASE to avoid cracking issues during thermal cycles (cell fabrication and testing). Additionally, it also has to be mechanically strong for maintaining the battery cell structure integrity and chemically stable without being corroded by electrode materials. The material composition of the unibody header is preferable to be the same material composition of the BASE, such as 60 weight % of Al₂O₃ and 40 weight % of YSZ as an example. Thermal expansion characterization tests were performed using the ASTM E-228 standard on a few bar samples made from the same compositions for MSRI's BASE and the unibody ceramic header.

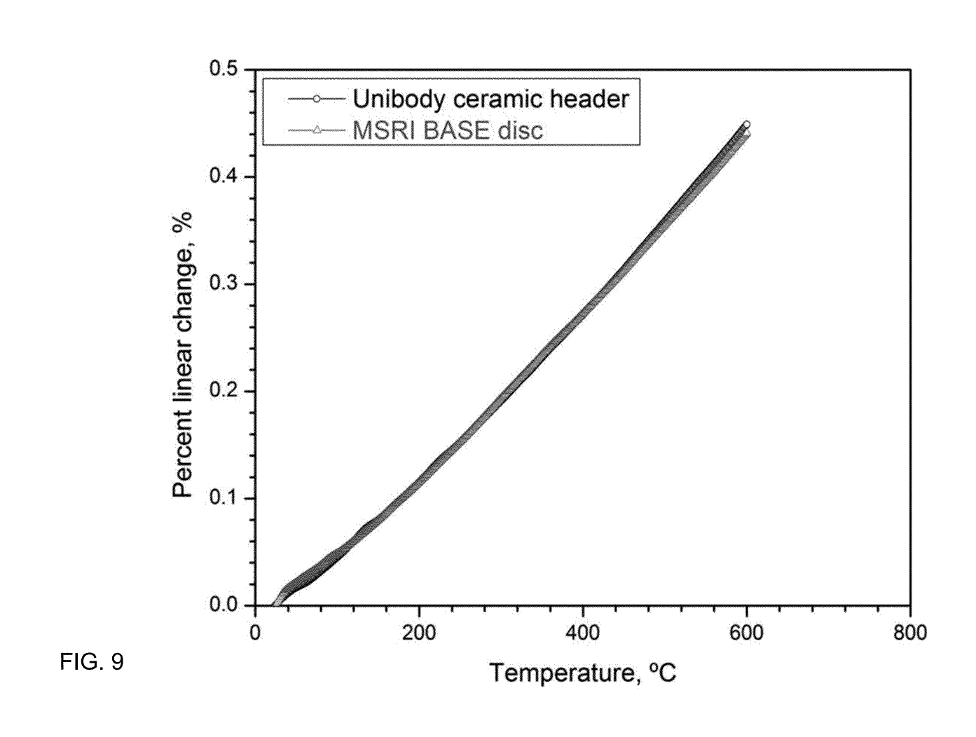

FIG. 9 shows the results of Percent Linear Change (PLC) over a temperature ranging from 25° C. to 600° C., indicating an excellent CTE match between the two battery cell components.

### Example VII

### Fabrication of Unibody Ceramic Headers with Molybdenum-Manganese Metallization for Cathode Compartment

Unibody Ceramic Header Fabrication

As described in Example VI above, the unibody ceramic header was made from corrosion-resistant refractory materials. A ceramic pellet was prepared by die-pressing a powder mixture of 60 weight % Al₂O₃ and 40 weight % YSZ powders, followed by bisquing (semifiring) at 1200° C. in air for a few hours. The pellet was then machined into a tube with its interior wall having a protruding rim by using the conventional metalworking tools, such as carbide tooling. The tube was then sintered at 1400° C. in air for one hour, forming a refractory unibody header.

Metallization of the Cathode Sealing Side and High-Temperature TCB Processing

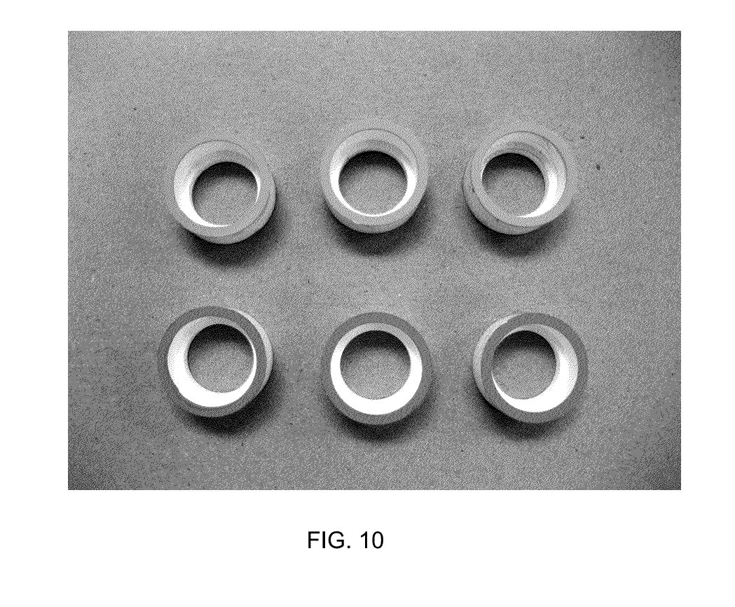

The thermocompression bonding technique, which is typically used for manufacturing commercial tubular ZEBRA batteries to joint α-alumina collars to mild steel cases, was adopted to bond a metal flange ring to the cathode side top surface of the ceramic header, as illustrated in FIG. 3. In order to reduce stress corrosion caused by the CTE mismatching between the unibody header and the metal ring, the ceramic header was first metallized on the cathode sealing side by applying a molybdenum-based layer, whose CTE was suitable for sealing to ceramic substrates. A molybdenum-manganese (Mo—Mn) paste was applied on the cathode sealing side via screen-printing, followed by firing at an elevated temperature (1300° C.˜1450° C.) for 1 hour in a reducing atmosphere. FIG. 10 shows six unibody ceramic headers after molybdenum-manganese metallization, which afterward were bonded to metal flange rings using TCB.

The high-temperature TCB process was used under a controlled reducing environment (e.g. 10% hydrogen gas balanced with nitrogen gas). A flange ring, such as mild steel, nickel, or stainless steel, was cut into a ring-shape with its internal diameter (ID) matching the ID of the cathode sealing area. The metal ring and the unibody ceramic header were assembled and heated to an elevated temperature (950° C.˜1050° C.) purged with the reducing gas. The assembly was then compressed to a few hundred pounds through a pushing rod seated in the center for a few minutes to ensure a good atomic bonding formed between the flange ring and the ceramic header through the Mo—Mn layer.

### Example VIII

### Nickel to Ceramic Bonding Characterization

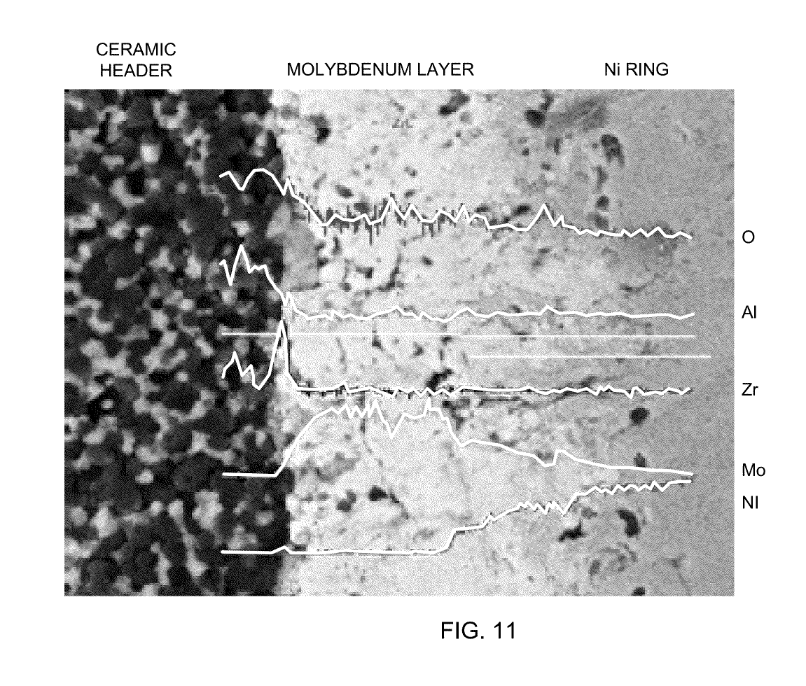

A nickel ring was used for bonding, and the nickel to ceramic header bonding was characterized by using a combination of SEM and energy-dispersive X-ray (EDX) spectroscopy. FIG. 11 shows the EDX spectroscopy of a ceramic-to-metal seal, indicating that excellent joints were formed.

### Example IX

### Metal-to-Ceramic Bonding for Anode Compartment

It is desirable to use an aluminum gasket to form the metal-to-ceramic bonding for the anode compartment because of inexpensive material and processing costs (at a lower temperature). In addition, aluminum is per se inert to molten sodium corrosion/attack. Rings were cut from a thin aluminum sheet with preferable thickness of 0.025 cm˜0.127 cm. Anode end covers were also cut from thin metal shims with preferable thickness of 0.005 cm˜0.05 cm. The choice of metal shim depends on the its resistance to sodium attack and the melting point. Examples of the metal for use as the anode end cover include, but are not limited to, aluminum, austenitic stainless steel, copper, crofer-22™, mild steel, and nickel.

A low-temperature TCB process was used to join the anode end cover 145 to the anode sealing side of the ceramic header 123, between which an aluminum ring 157 is sandwiched, as shown in FIG. 3. The low-temperature TCB process was used at a temperature ranging from 430° C. to 550° C. Since the battery cell is assembled under a fully discharged state, no metallic sodium is pre-filled into the anode compartment. During the break-in charge and afterwards the charge/discharge cycles, molten sodium is moved to/away from the anode compartment, resulting in anode volume changes that accompany with gas pressure changes if any residual gas is present in the anode compartment. This may result in breaking up the anode sealing joints under an extreme case. The section below examines the anode residual gas effects on the anode compartment gas pressure that the anode seals have to withstand.

The low-temperature TCB was processed preferably under a vacuum to ensure that the anode compartment is free of any gas after bonding. Nevertheless, in order to adapt to pressure changes during the break-in and afterwards charge/discharge cycles in case that any gas is present in the anode compartment 125, the anode end cover 145 (FIG. 3) was stamped into wave forms 147 serving as a diaphragm for providing compliancy to pressure changes. Thereafter, combining the TCB processing under vacuum with a diaphragm design of the anode end cover, safety of battery operation is greatly improved.

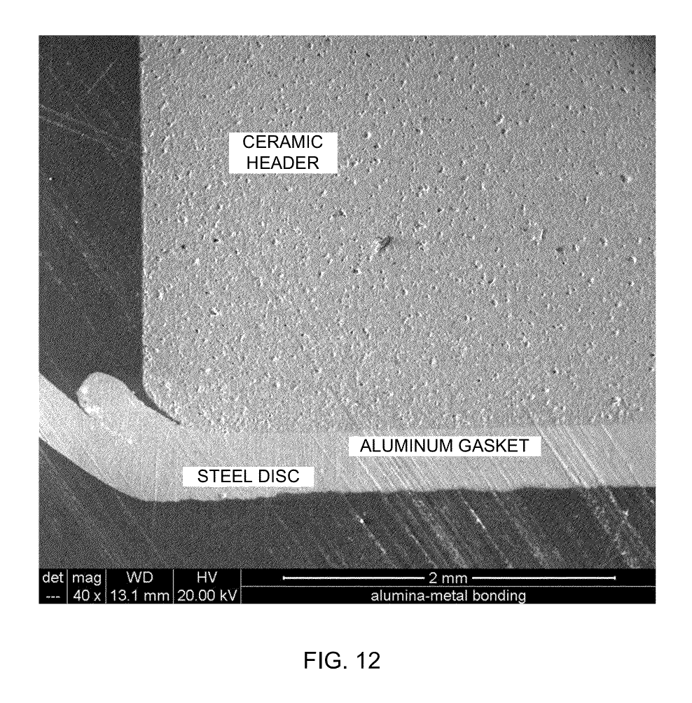

FIG. 12 shows a SEM micrograph of joints formed to the anode of a ceramic header, an aluminum gasket ring, and a mild steel disc after TCB process. The sample was prepared by encapsulation with epoxy resin in a castable mold and sectioned, followed by polishing.

### Example X

### Study of the Anode Residual Gas Effects on the Anode Compartment Pressure

As described above, unlike the Na—S battery, the alkali metal-metal halide battery is typically assembled under a fully discharged state; consequently, no metallic sodium is pre-filled into the anode compartment. During the break-in charge and afterwards the charge/discharge cycles, molten sodium is moved to/away from the anode compartment, thus resulting in anode volume changes accompanying with gas pressure changes if any residual gas is present in the anode compartment. This possibly may result in breaking the anode seals under certain extreme conditions. To investigate the effects of a residual gas on the anode compartment gas pressure that potentially the anode seals may have to withstand, a case study was conducted in four different anode environments after the final assembly of an alkali metal-metal halide battery cell. After the final assembly, an anode environment at a room temperature (25° C.) can be:

case 1. an inert gas (e.g. Argon) at 1 atmosphere (atm), or equivalent to 101325 pa;

case 2. air at 1 atmosphere;

case 3. oxygen at 1 atmosphere;

case 4. vacuum, which is readily achievable to be ˜100 pa (when an Edwards vacuum pump (e.g. RV-5) was used during the low-temperature TCB process to form anode seals, as described in Example IX above).

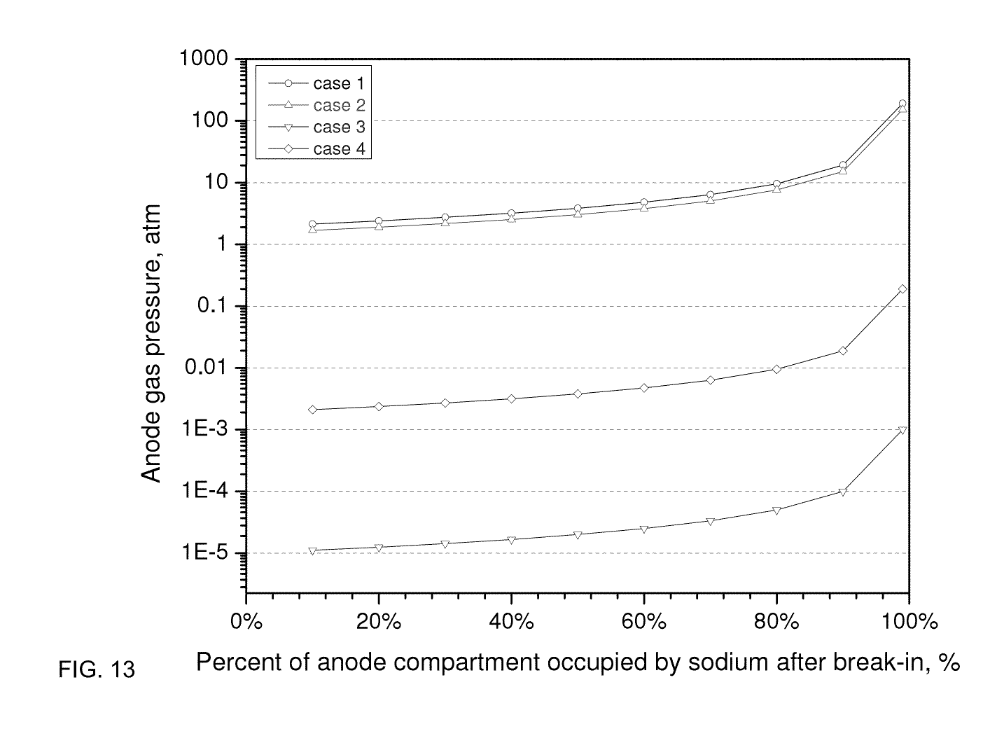

FIG. 13 shows the case study results of the residual gas effects on the anode compartment pressure after the break-in charge at 300° C. Clearly the more the anode compartment space is occupied by sodium, the higher the gas pressure will be. Assuming 90% of the anode compartment space is occupied by sodium after the break-in, the gas pressure is estimated to be over 19.2 atm and 15.2 atm for Case 1 and Case 2, respectively. Such a high pressure can result in breaking up the anode seals, or rupture of the BASE or the glass seals. In contrast, the gas pressure for Case 3 and Case 4 are very benign, allowing for significant space to be occupied without pressure issues. However, the penalty for Case 3 is that during the break-in, a part of sodium is consumed by the residual oxygen at a rate of 3.76 milligram per cubic centimeter of the anode compartment space. For example, for an anode compartment with 40 cubic centimeter space, nearly 150.4 milligram of sodium will be wasted after the break-in, which is equivalent to a loss of 0.1753 Ah of battery capacity. In addition, a non-conductive Na₂O is formed and very likely will deposit between the BASE and the graphite felt, resulting in the formation of an electrically insulating layer.

### Example XI

### Hermeticity Test of Joints Formed by a Ceramic Header, an Aluminum Gasket, and a Mild Steel Cover

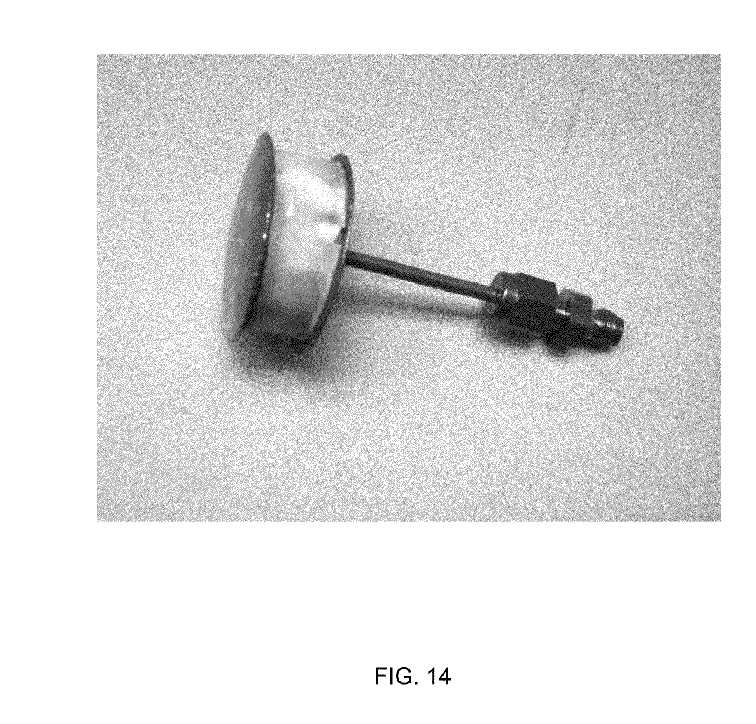

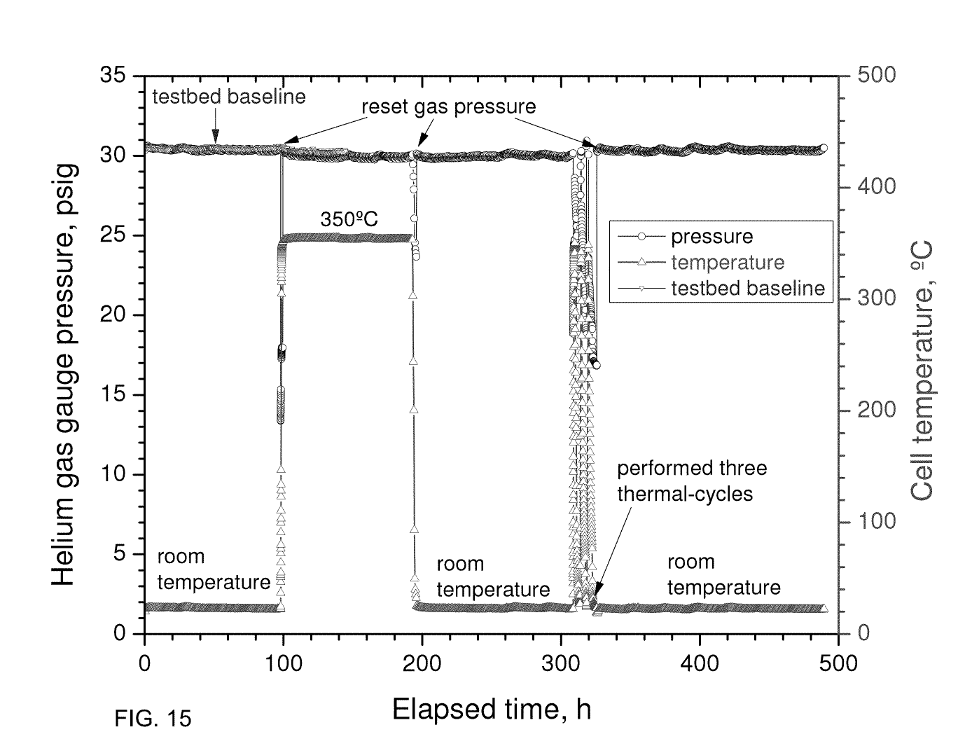

The hermeticity of the sealing joint on the battery anode is the most critical to ensure that the anode material (molten sodium) does not oxidize by exposure to atmospheric air. Any sign of leak to atmosphere will cause chemical reactions of liquid sodium with air or moisture, resulting in the formation of unfavorable gas (H₂), loss of battery capacity, or fire hazards under extreme cases. Therefore, the hermeticity and the bonding strength of the anode joint were studied by the helium leak-rate test. As shown in FIG. 14, symmetric bonding joints were formed on both sealing sides of a unibody ceramic header by thermocompression bonding aluminum gasket rings and mild steel discs. For this test, neither BASE electrolyte nor electrode materials were loaded inside the ceramic header. On one side, a ⅛″ stainless tube was brazed to the steel disc for passing a pressurized gas. This assembly was connected to a leak-rate test bed with Swagelok connection, as shown in the figure. The leak-rate test was performed with the ceramic header pressurized to 30.5 psig (or 3 absolute atmospheres) from a helium gas source (bottle), followed by disconnecting the header from the gas source. The pressure changes were measured by a Baratron Pressure Transducer Type 740B (MKS) and recorded over a period of time. During the test, the assembly was also thermally cycled from room temperature to 350° C. to study the effects of cycling on the hermeticity and the bonding strength of the joints. Due to the pressure change with temperatures, the assembly was de-pressurized first before each thermal cycle, and was pressurized again back to 30.5 psig for the leak-rate test over time. The leak rate of the test-bed without assembly was also measured as a baseline. FIG. 15 shows the test results, along with the test-bed baseline leak-rate measurements. As shown in the figure, over a nearly 500-hour continuous test at both room temperature and 350° C., the helium leak-rate was negligible even after four thermal cycles from room temperature to 350° C., indicating that satisfactory sealing joints were achieved with sufficient strength and hermeticity.

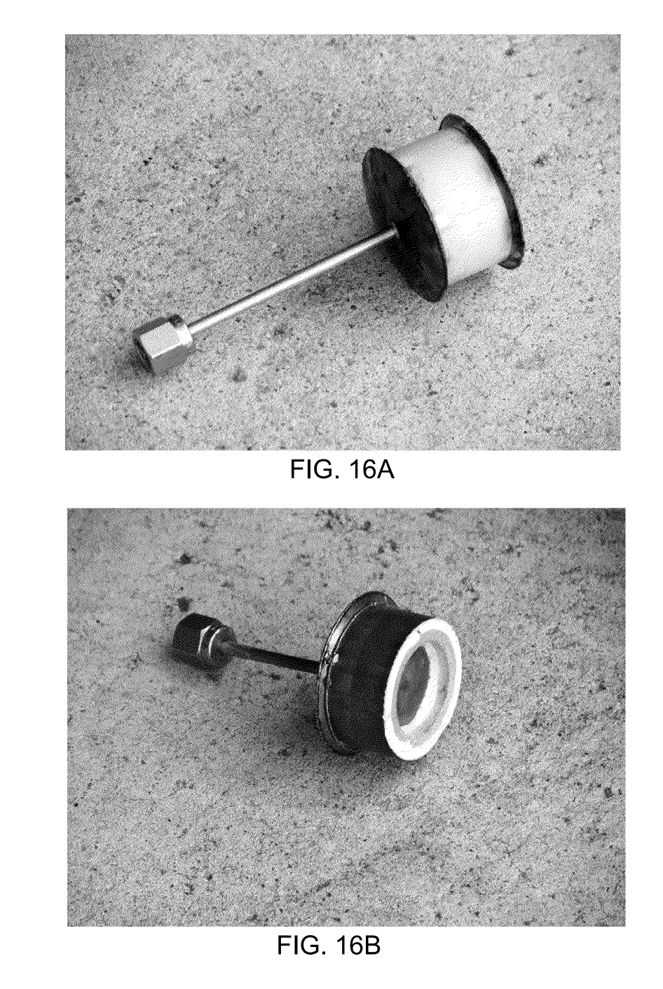

“Pop” tests were also performed on a few selected assemblies after the leak-rate tests to exam the pressure endurance ability of TCB seals, glass seals, and welding joints when exposure to a high pressure gas. Instead of measuring the leak rate at a constant gas pressure (30.5 psig), the assembly was pressurized on the same leak-rate test bed with the helium gas gradually to 100 psig (due to the pressure regulator limit). The pressure changes were measured by the transducer and recorded over time. Whenever a rapture of BASE disc, TCB seals, or welding joints happens, the gas pressure drops immediately. FIG. 16A shows an assembly to test a seal between a ceramic header and the top cap sealed by TCB (Mo—Mn) bonding of a cathode-type cover on both sides. FIG. 16B shows a test assembly with a ceramic header with a BASE disc glass sealed on one end and a TCB (Al) bonded disc (corresponding to an anode cover). The photos show the assemblies after the test.

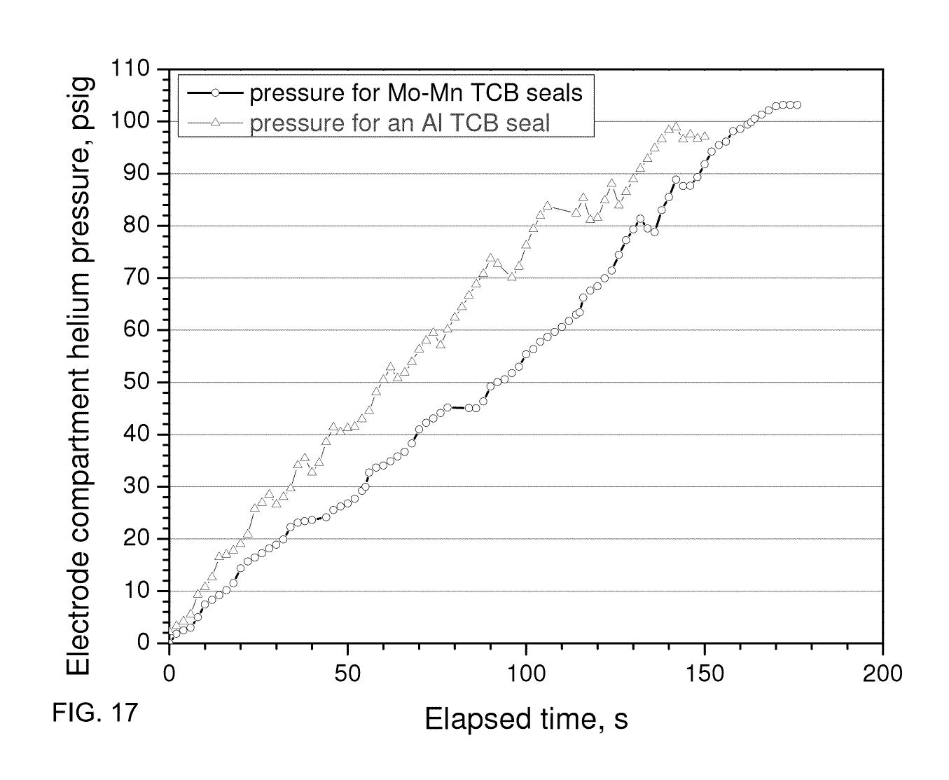

FIG. 17 shows the test results of two selected assemblies: the assembly with symmetric high-temperature TCB bonding (Mo—Mn) seals without a BASE disc (FIG. 16A), and the assembly with a long-temperature TCB bonding (Al) seal and a MSRI's BASE disc glass sealed to the unibody header (FIG. 16B). As shown in the plots and the photographs, no sign of rapture was observed even after exposure to 100 psig gas, indicating the excellence of the battery design and battery cell component consideration described above.

### Example XII

### Construction of a Planar Na-Nickel Chloride Single-Cell Battery

This gives an example of constructing a planar, alkali metal-beta single-cell battery with the Na/NiCl₂ electrochemical couple. The process involved electrode compartment fabrication, active cathode material preparation, anode material preparation, and final assembly.

Anode/Cathode Compartment Construction

A Na-BASE disc fabricated in Example I, and/or Example V was glassed to the protruding rim from the inside of the unibody ceramic header, which was prepared in Example VII. The glass not only provided hermetic sealing between the Na-BASE disc and the protruding rim, but also separated the unibody ceramic header into an anode compartment and a cathode compartment. The glass consisted of a formulation of borosilicate or boroaluminate that has a high resistance to sodium attack and its CTE matches to both Na-BASE and the ceramic header. Due to the possible oxidation issues of nickel and molybdenum, the glassing process was performed in a reducing atmosphere, e.g. 10% H₂ bal. N₂. The diameter and the thickness of the Na-BASE disc were 2.9 cm and 0.12 cm, respectively.

Cathode Preparation

Cathode was prepared by forming a single pellet consisting of active cathode materials. NaCl and Ni powders were mixed at a certain ratio, varying from 1/1 to 1/3 by weight, followed by dry ball-milling for 10 minutes. Trace amount of FeS₂, NaI and NaF were added into the powder mixture to enhance the battery performance. A pore-former, such as (NH₄)₂CO₃, was blended to the cathode mixture to form pores after decomposition at elevated temperatures. The powder mixture was then die-pressed into pellets with a current conducting strip embedded partially inside each pellet. The current conducting strip was preferably of nickel, nickel-clad copper, or nickel-clad steel. After pressing, each pellet had a diameter and thickness of 2.54 cm and 0.77 cm, respectively. The pellet was thereafter heated in a Teflon beaker to 200° C. for 30 minutes to burn out the pore-former, leading to the formation of a cathode skeleton mainly consisting of Ni and NaCl with 50˜60% porosity. The cathode pellet was then further heated to 250° C., followed by infiltration of the secondary electrolyte (NaAlCl₄) under vacuum. After cooling down to room temperature, the resulting cathode pellet was then wrapped with a thin aluminum foil in a glove-box, and ready for final assembly of a single-cell battery.

A small amount of aluminum powder (e.g. 100 mesh) mixed with an appropriate amount of NaCl was added to the cathode compartment to replenish sodium and NaAlCl₄ upon reacting with NaCl (typically at 9/1 weight ratio of NaCl/Al).

Single-Cell Battery Assembly

The final assembly of a single-cell battery was completed by welding the current conducting strip 137 to the inside of the knob of the cathode end cover 133, followed by welding a bellows 135 to the cathode end cover 131 and the TCB ring 151, as shown in FIG. 3. The bellows 135 can be either welded or formed bellows, and can be constructed from any suitable material, such as the same material of the cathode end cover (e.g. mild steel).

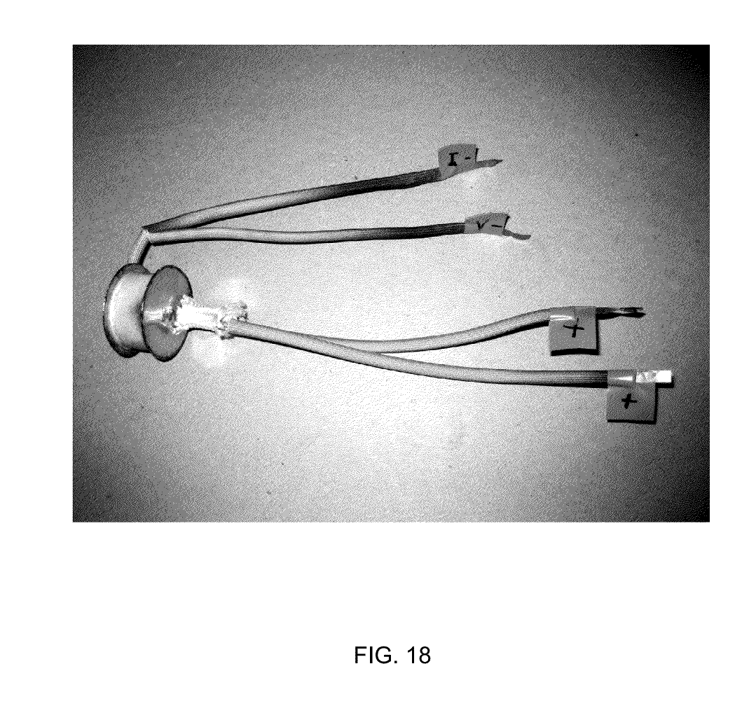

Alternatively, the cathode end cover and the bellows can be replaced simply by a diaphragm with a knob stamped in center. Since the battery chemistries (NaAlCl₄ and products of Na and NiCl₂) are very hydrophilic, the welding process was carried out at room temperature inside an argon-filled glove-box to eliminate any source of environmental air and moisture during the final assembly. The welding joints were examined under a microscope to ensure high quality. To electrochemically test a single-cell battery, current and voltage probes were welded to the cell, one of each to both end covers. FIG. 18 is a photograph of the planar, Na—NiCl₂ single-cell battery assembly ready for testing.

### Example XIII

### Test Protocol for a Planar Na-Nickel Chloride Battery Cell

A test protocol, as elaborated in detail in Table 1, was developed to characterize the performance of a planar Na—NiCl₂ single-cell battery. The battery located in the middle of a box furnace was heated to the operating temperature (300° C.) in less than 30 minutes. A break-in charge was performed at a constant current control mode (or CC mode) with a current set to ˜30 mA. The continuing break-in charge was extended until the cell voltage reached 2.65V after which the operation automatically switched to the constant voltage control mode, or CV mode. The conditioning cycles were carried out at the CC mode by setting the current typically less than ⅓C (e.g., 100 mA, 150 mA, or 250 mA, depending on the cell capacity). Charge/discharge tests were performed under the CC mode with the current setting to ½C. As a safety feature, the cut-off voltages were typically set to 1.7 V (low limit) and 3.1 V (upper limit) to avoid damage due to over-discharge/over-charge. In some cases, a reconditioning test was performed after the cycling tests which were continued afterward. During the charge/discharge, the cell current was interrupted at scheduled times (e.g. every 5 minutes) to perform the current-interruption for the characterization of the cell resistance.

TABLE 1
Test protocol for p-ZEBRA battery evaluation

| Steps | Tests | Remarks |
|---|---|---|
| #1 | Heat-up | from room temperature to 300° C. with a ramp- |
| | | rate set to 10° C./min. |
| #2 | Break-in (initial | constant current at 30 mA (0.03 A), or until |
| | charge) | voltage reached 2.65 V. |
| #3 | Conditioning | charge/discharge under constant current |
| | cycles | (typically less than ⅓ C). |
| #4 | Cycle tests | charge/discharge cycle tests under constant |
| | | current (typically ½ C) over 2 hrs/2 hrs or |
| | | cut-off voltage: upper limit @ 3.1 V, low |
| | | limit @ 1.7 V. |
| | | current-interruption every 5 minutes to measure |
| | | the OCV and the cell resistance. |
| #5 | Reconditioning | similar to the break-in test but until voltage |
| | test | reached 2.7 V. |

### Example XIV

### Break-in Characteristics of a Planar Na-Nickel Chloride Battery Cell

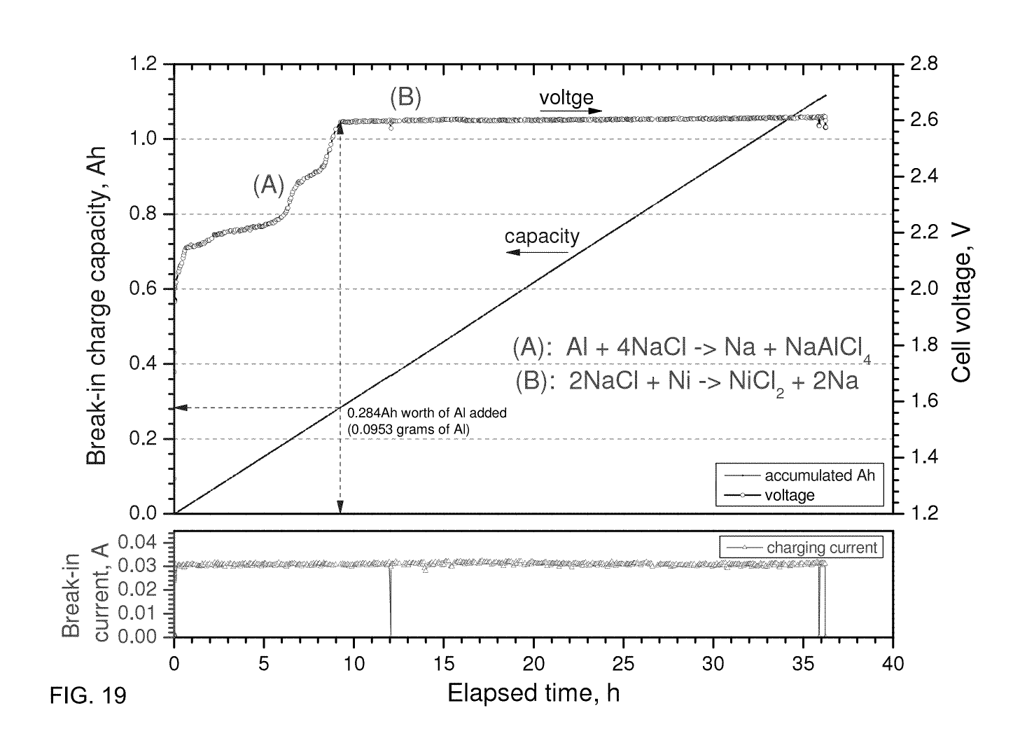

FIG. 19 shows a typical break-in characteristic of a planar Na—NiCl₂ over 36 hours. The current was fixed at 30 mA, and the corresponding cell voltage increased slowly to the cut-off 2.65 V. The break-in charge capacity was calculated and shown in the solid line. It was observed interestingly that the cell voltage showed unique characteristics during the break-in test. The voltage jumped from 1.3 V to 1.95 V within the first few seconds, then slowly climbed to 2.59 V in the first 9.5 hours, followed by another 27 hours of gradual increase to 2.65 V. These characteristics responded to at least two different electrochemical reaction mechanisms. The first 9.5-hour reaction was associated with the presence of aluminum in the cathode, forming the secondary electrolyte (on cathode) and sodium (on anode): Al+4NaCl→3Na+NaAlCl₄. The corresponding OCV of that reaction was ˜1.58 V at 300° C. The accumulated capacity was ˜0.284 Ah, or equivalent to the consumption of 0.0953 grams of aluminum. This was consistent with the amount of aluminum (0.1 gram) originally added to the cathode. The second reaction was associated with the battery charge reaction: 2NaCl+Ni→NiCl₂+2Na, with an OCV of 2.58 V. The total accumulated break-in capacity was ˜1.116 Ah.

### Example XV

### Performance Characteristics of a Planar Na-Nickel Chloride Battery Cell

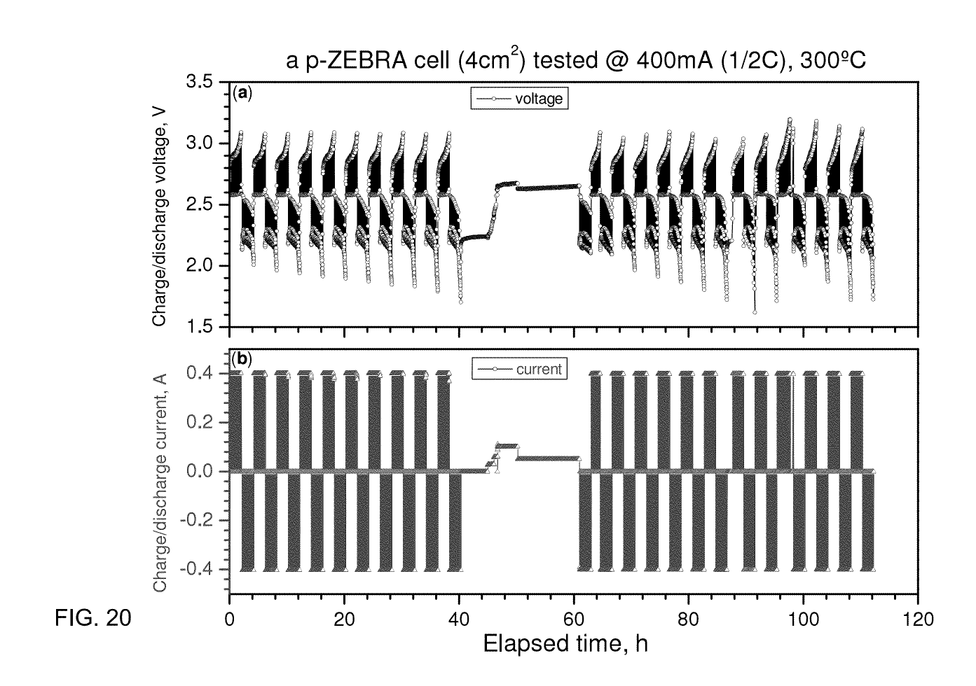

Following the break-in and conditioning tests that typically were performed at a relatively low current, e.g. ⅕C, the charge/discharge cycles were conducted at a current of ½C. FIG. 20 shows an example of the voltage characteristics of a planar Na—NiCl₂ cell. As shown in the figures, the cell was cycled for 22 times at ½C rate (400 mA or 100 mA/cm²) over 112 hours. After the first 10 cycles, the cell was reconditioned, followed by another 12 cycles. Cell voltage degradation was observed along with the increased charging voltages and decreased discharging voltages. This cell showed a capacity of 775 mAh, close to the 800 mAh capacity that was originally targeted at ½C rate (due to the time spent in OCV measurements). The energy capacity was over 270 Wh/kg of active cathode materials (excluding NaAlCl₄) when cycled at ½C (100 mA/cm²) rate at 300° C.

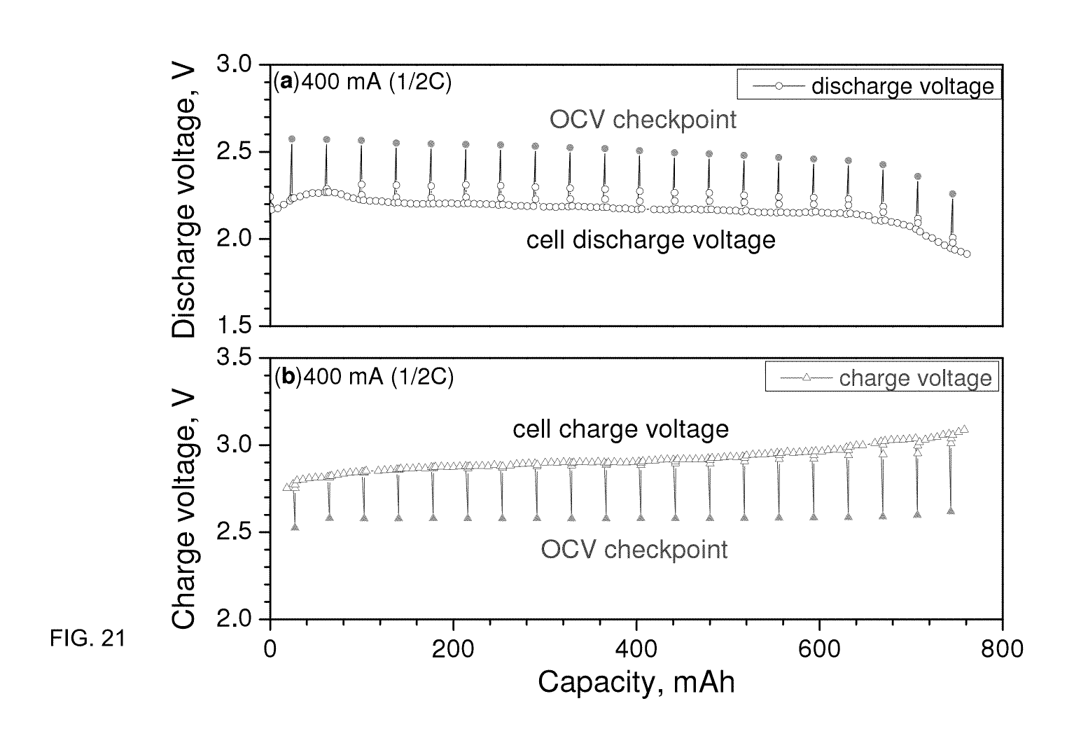

As defined in the test protocol, a scheduled current-interruption test was performed to measure the OCV during charge/discharge cycles. The OCV dependency on the state-of-charge (SoC) is shown in FIG. 21, as a real-time barometer indicating the healthy status of the battery:

(a) over-charge if OCV>3.05, corresponding to reaction 2NaAlCl₄+Ni→NiCl₂+2AlCl₃+2Na;
(b) over-discharge if OCV<1.58, corresponding to reaction 3Na+NaAlCl₄→4NaCl+Al;
(c) or rupture of electrolyte, short, or leak, if OCV<<1 V

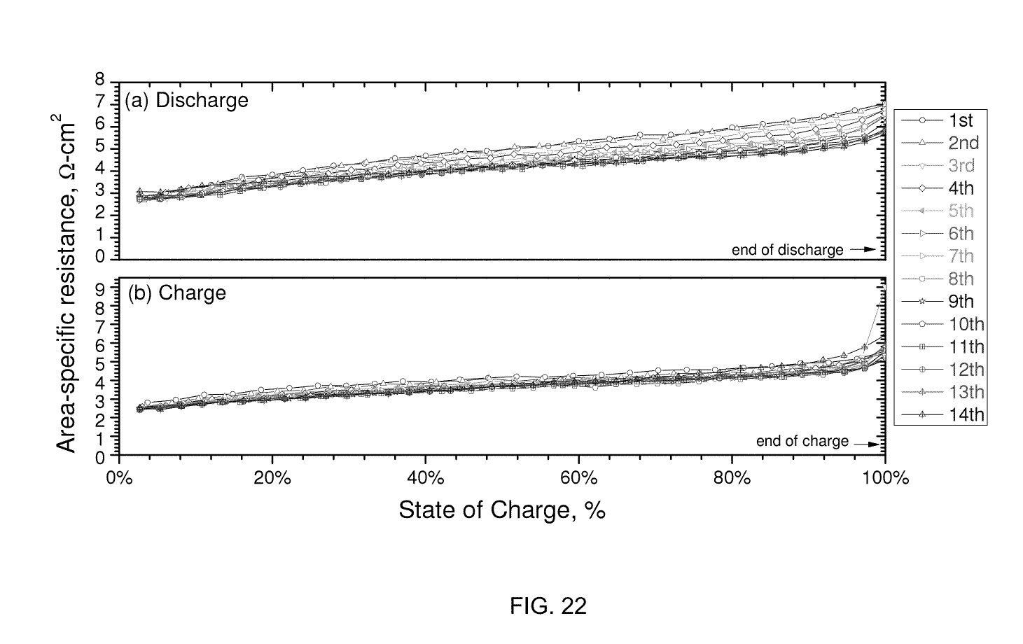

Based-on the real-time OCV measurement, the cell ASR was calculated [ASR=(V_{cell}−V_{OCV})/I*4], and the dependency on the SoC was plotted in FIG. 22. Clearly, the ASR increased by the end of events (both discharge and charge), e.g. from 2.8 Ωcm² to 6 Ωcm². With a thickness of 0.12 cm and a conductivity of 0.1 S/cm at 300° C., the electrolyte ohmic ASR was about ˜1.2 Ωcm², which contributed significantly to the total ASR.

### Example XVI

### Freeze/Thaw Test of a Planar Na-Nickel Chloride Battery Cell

Freeze-thaw survivability of tubular sodium-beta batteries has long been known to be a concern, particularly for the NaS battery. The BASE has to endure high stress resulting from phase transformation of the sulfur electrode during thermal cycles. Due to low fracture strength (<200 MPa), the Na—S battery constructed with conventional BASE exhibits limited freeze-thaw cycles (e.g. 10 cycles). However, as discussed previously, the present planar alkali metal-beta battery is expected to exhibit exceptional freeze-thaw survivability.

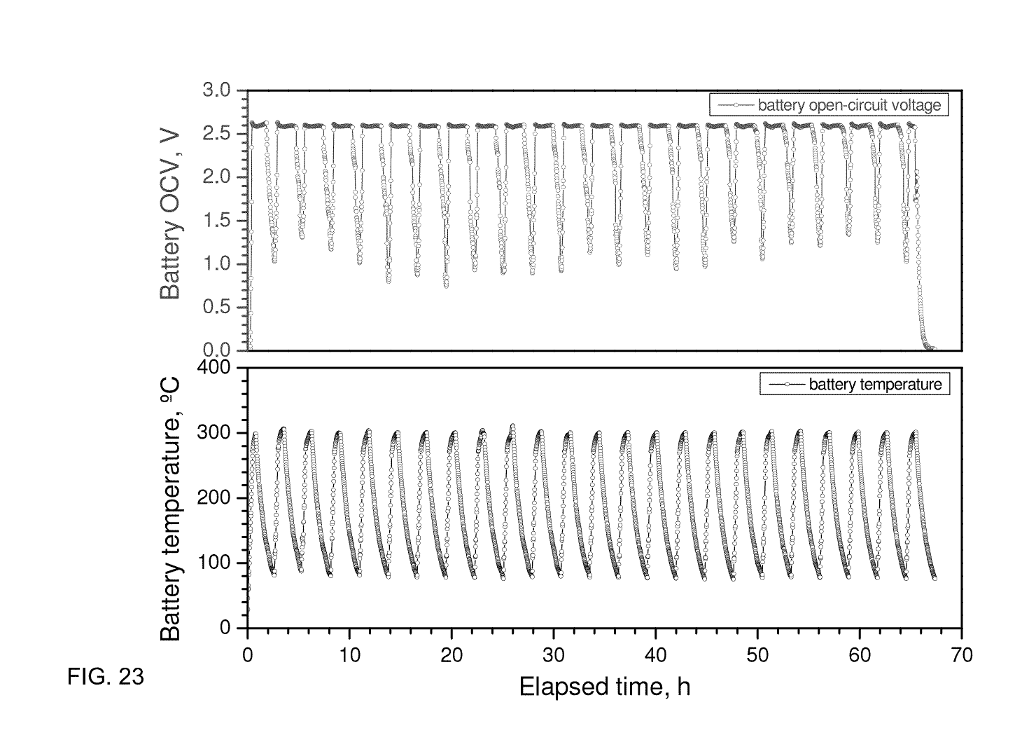

In order to validate this anticipated merit, accelerated freeze-thaw tests were executed. Though no immediate references were available, except the Na—S battery development reports published by SPI (the Na—S battery heating rates were set to 15° C./h and 30° C./h), a protocol for accelerated freeze-thaw tests was defined as below. (see A. Koenig and J. Rasmussen, “Sodium/Sulfur battery engineering for stationary energy storage”, final report, Silent Power Inc., 1996) A battery cell was heated to 300° C. at a rate of 720° C./h (or 12° C./min), followed by soaking at 300° C. for 30 minutes and cooling down to 70° C. that was below the freezing temperatures of both Na and NaAlCl₄. The cooling step typically took 1.5 hours due to large thermal mass of the furnace. Cells in a half-charged stage were subjected to the freeze-thaw cycles. During the freeze-thaw test, an automated LabView program recorded the cell voltage (OCV), which was used as a pass/fail criterion. FIG. 23 shows the results of a planar Na—NiCl₂ battery thermally cycled between 70° C. and 300° C. for 24 cycles. The battery survived all freeze-thaw cycles.

While invention has been described with reference to certain specific embodiments and examples, it will be recognized by those skilled in the art that many variations are possible without departing from the scope and spirit of the invention, and that the invention, as described by the claims, is intended to cover all changes and modifications which do not depart from the spirit of the invention.

1. A battery cell comprising:
a unibody ceramic header;
a planar alkali-ion-conducting solid electrolyte,
the header generally cylindrical shaped with a generally cylindrical hollow interior with first open and second open ends,
the cylindrical interior of the ceramic header configured with a protruding rim engaging and sealed to the edges of the solid electrolyte to separate the hollow interior into separate compartments, a cathode compartment opening at the first end, and an anode compartment opening at the second end;
cathode end cover at the first end closing the cathode compartment with a seal;
anode end cover at the second end closing the anode compartment with a seal,
a solid unitary compressed cathode pellet sealed in the cathode compartment, the pellet comprising active cathode materials.

2. The cell of claim 1 wherein the active cathode materials are compressed into the solid cathode pellet include NaCl and nickel, and are infiltrated with a NaAlCl₄ secondary electrolyte under vacuum.

3. The cell of claim 1 wherein upon first assembly before charging the anode compartment is evacuated of gasses.

4. The cell of claim 1 wherein the planar alkali-ion-conducting solid electrolyte has textured surface adjacent to either or both the anode and the cathode.

5. The cell of claim 1 wherein the planar alkali-ion-conducting solid electrolyte has a planar shape chosen from any one of circular, ovoid, regular or irregular polygonal with straight or curved sides, and the cylindrical interior of the ceramic header having a corresponding cross-section.

6. The cell of claim 1 wherein the ceramic header and the planar alkali-ion-conducting solid electrolyte have matching coefficients of thermal expansion to reduce stresses leading to cracking during thermal cycles.

7. The cell of claim 1 wherein the cell is assembled into a stack of similar cells in a series configuration.

8. The cell of claim 7 having a knob near the center of the cathode end cover to improve electrical contact with an anode end cover of an adjacent cell and assist in registration with the adjacent cell.

9. The cell of claim 7 wherein either or both of the anode cover and cathode cover have a surface for attachment of a bypass clamp to electrically bypass the cell or an adjacent cell.

10. The cell of claim 1 having a bellows disposed between the ceramic header and the cathode end cover, the bellows compliantly constructed to respond to changing volume and pressure conditions in the cathode compartment.

11-14. (canceled)

15. A battery cell comprising:
a unibody ceramic header;
a planar alkali-ion-conducting solid electrolyte,
the header generally cylindrical shaped with a generally cylindrical hollow interior with first open and second open ends,
the cylindrical interior of the ceramic header configured with a protruding rim engaging and sealed to the edges of the solid electrolyte to separate the hollow interior into separate compartments, a cathode compartment opening at the first end, and an anode compartment opening at the second end;
cathode end cover at the first end closing the cathode compartment with a seal;
anode end cover at the second end closing the anode compartment with a seal,
a bellows disposed between the ceramic header and the cathode end cover, the bellows compliantly constructed to respond to changing volume and pressure conditions in the cathode compartment.

16-26. (canceled)

27. A stack of planar cylindrical battery cells, each cell comprising a cylindrical unibody ceramic header supporting an interior planar alkali-ion-conducting solid electrolyte with a cathode cover on an end of the cylindrical ceramic unibody header, and an anode cover on an opposite end of the cylindrical ceramic header to form respective cathode and anode compartments,
the cells stacked with adjacent cathode and anode covers, to provide physical and electrical contact between adjacent covers, the cathode cover of each cell having a knob near its center to provide electrical contact and provide physical contact with an adjacent anode cover, and provide physical registration with the adjacent cell.

28. The stack of claim 27 wherein the cathode cover and the anode cover of each cell are constructed to provide an external surface for attachment of a by-pass clamp that electrically bypasses one or more cells by physically and electrically connecting covers across one or more ceramic unibody headers.

29. (canceled)

30. (canceled)

31. A stack comprising a plurality of cylindrical battery cells as in claim 15, the cells stacked with adjacent cathode and anode covers, to provide physical and electrical contact between adjacent covers.

32. The stack of claim 31 wherein each cell additionally comprises a solid unitary compressed cathode pellet sealed in the cathode compartment, the pellet comprising active cathode materials.

33. The stack of claim 31 wherein the active cathode materials are compressed into the solid cathode pellet include NaCl and nickel, and are infiltrated with a NaAlCl₄ secondary electrolyte under vacuum.

34-38. (canceled)

39. The stack of claim 31 wherein each cell has a knob near the center of the cathode cover to improve electrical contact with an anode cover of an adjacent cell and assist in registration with the adjacent cell.

40. (canceled)

41. The battery cell of claim 1 wherein the anode end cover is a stamped flat metal shim with waves in the center.
